(19) United States
(12) Patent Application Publication
(10) Pub. No.: US 2026/0077263 A1
(43) Pub. Date: Mar. 19, 2026

(54) COMPUTING RESOURCE MANAGEMENT FOR CLOUD GAME CONTROL

(71) Applicant: NETEASE (HANGZHOU) NETWORK CO., LTD., Hangzhou (CN)

(72) Inventor: Shengmeng ZHOU, Hangzhou (CN)

(21) Appl. No.: 19/109,966

(22) PCT Filed: Mar. 21, 2023
(86) PCT No.: PCT/CN2023/082817

§ 371 Date: Mar. 7, 2025

(30) Foreign Application Priority Data
Sep. 9, 2022 (CN) 202211105048.X

(51) Int. Cl. A63F 13/35

(52) U.S. Cl. CPC A63F 13/35; A63F 2300/51

(57) ABSTRACT

According to some aspects of the present disclosure, control instructions for target cloud game resources in a system instance are acquired. Based on the control instructions, a respective target resource group corresponding to each respective target cloud game resource of the target cloud game resources is determined. For each respective target resource group, a respective target cloud game application is displayed through a respective target display resource, each respective target cloud game resource is run through the respective target cloud game application, and a respective control operation corresponding to a respective control instruction is executed. Each respective target cloud game resource is processed through a corresponding target processing resource to obtain pieces of cloud game data, and the pieces of cloud game data are returned to one or more senders of the control instructions.

The present disclosure is a 371 national phase application of PCT Application No. PCT/CN2023/082817 filed on 21 Mar. 2023, which claims priority to Chinese Patent Application No. 202211105048.X filed with the China National Intellectual Property Administration on 9 Sep. 2022 and titled “CLOUD GAME CONTROL METHOD AND APPARATUS, ELECTRONIC DEVICE, AND STORAGE MEDIUM”, the entire contents of both of which applications are hereby incorporated by reference for all purposes.

### TECHNICAL FIELD

The present disclosure relates to the technical field of computers, and particularly relates to a method for controlling a cloud game, an apparatus for controlling a cloud game, an electronic device, and a storage medium.

### BACKGROUND

Cloud gaming is a novel way of running a game based on cloud computing. In the cloud gaming mode, rendering of a game resource is completed on a server side. The rendered game resource is encoded, and then streamed to a terminal of a game player through a network. The game player can play the game only based on a basic video decoding capability without the need of a high-end game device at the terminal.

At present, a plurality of existing technical solutions for implementing a cloud game on a single device are virtualization or containerization. Both of them are to set up a plurality of system instances on the single device, and each of the system instances is used to transmit a cloud game. However, each system instance needs to run its own processes, as well as some necessary system applications, and may even need to run an independent kernel, wherein many of the processes are repeated, which will bring some considerable expenditures, and the plurality of system instances need to share a resource, such as a GPU or a CPU, in the single device. When a plurality of games are played simultaneously, some difficult problems may still arise during scheduling.

Therefore, a current method for implementing a plurality of cloud games using a single device has technical problems such as system resource waste and scheduling difficulty, and needs to be improved.

### SUMMARY

According to a first aspect, the present disclosure provides a method for controlling a cloud game, including: acquiring N control instructions for N target cloud game resources in a system instance, wherein: the system instance comprises M resource groups, each of the resource groups comprises one or more interrelated cloud game applications, one or more display resources, and one or more processing resources, M and N are positive integers, and M is larger than or equal to N; determining, based on the N control instructions, a respective target resource group corresponding to each respective target cloud game resource of the target cloud game resources; displaying, for each respective target resource group, a respective target cloud game application through a respective target display resource; running each respective target cloud game resource through the respective target cloud game application; executing, on each respective target cloud game resource associated with a respective control instruction, a respective control operation corresponding to the respective control instruction; processing each respective target cloud game resource through a corresponding target processing resource to obtain N pieces of cloud game data; and returning the N pieces of cloud game data to one or more senders of the N control instructions.

According to a second aspect, the present disclosure provides an electronic device, comprising a memory and one or more processors, wherein the memory stores an application program, and the one or more processors are configured to run the application program in the memory to perform an operation for controlling a cloud game, comprising: acquiring N control instructions for N target cloud game resources in a system instance, wherein: the system instance comprises M resource groups, each of the resource groups comprises one or more interrelated cloud game applications, one or more display resources, and one or more processing resources, M and N are positive integers, and M is larger than or equal to N; determining, based on the N control instructions, a respective target resource group corresponding to each respective target cloud game resource of the target cloud game resources; displaying, for each respective target resource group, a respective target cloud game application through a respective target display resource; running each respective target cloud game resource through the respective target cloud game application; executing, on each respective target cloud game resource associated with a respective control instruction, a respective control operation corresponding to the respective control instruction; processing each respective target cloud game resource through a corresponding target processing resource to obtain N pieces of cloud game data; and returning the N pieces of cloud game data to one or more senders of the N control instructions.

According to a third aspect, the present disclosure provides a non-transitory computer-readable storage medium, storing a computer program thereon, wherein the computer program can be executed by one or more processors to perform an operation for controlling a cloud game, comprising: acquiring N control instructions for N target cloud game resources in a system instance, wherein: the system instance comprises M resource groups, each of the resource groups comprises one or more interrelated cloud game applications, one or more display resources, and one or more processing resources, M and N are positive integers, and M is larger than or equal to N; determining, based on the N control instructions, a respective target resource group corresponding to each respective target cloud game resource of the target cloud game resources; displaying, for each respective target resource group, a respective target cloud game application through a respective target display resource; running each respective target cloud game resource through the respective target cloud game application; executing, on each respective target cloud game resource associated with a respective control instruction, a respective control operation corresponding to the respective control instruction; processing each respective target cloud game resource through a corresponding target processing resource to obtain N pieces of cloud game data; and returning the N pieces of cloud game data to one or more senders of the N control instructions.

### DESCRIPTION OF DRAWINGS

Embodiments of the present disclosure are described in detail below with reference to the drawings, so that the technical solutions and other beneficial effects of the present disclosure are obvious.

FIG. 1 is a schematic diagram of an application scenario of a method for controlling a cloud game provided in one of embodiments of the present disclosure.

FIG. 2 is a schematic flowchart of a method for controlling a cloud game provided in one of embodiments of the present disclosure.

FIG. 3 is an overall architecture diagram of a method for controlling a cloud game provided in one of embodiments of the present disclosure.

FIG. 4 is a schematic structural diagram of an apparatus for controlling a cloud game provided in one of embodiments of the present disclosure.

FIG. 5 is a schematic structural diagram of an electronic device provided in one of embodiments of the present disclosure.

### EMBODIMENTS OF THE PRESENT DISCLOSURE

Reference will now be described in detail to examples, which are illustrated in the accompanying drawings. The following description refers to the accompanying drawings in which the same numbers in different drawings represent the same or similar elements unless otherwise represented. The examples described following do not represent all examples consistent with the present disclosure. Instead, they are merely examples of devices and methods consistent with aspects of the disclosure as detailed in the appended claims.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

It should be understood that although terms “first”, “second”, “third”, and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if” used herein may be explained as “when” or “while”, or “in response to . . . , it is determined that”.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

Embodiments of the present disclosure provide a method for controlling a cloud game, an apparatus for controlling a cloud game, an electronic device, and a storage medium, to alleviate the technical problems of system resource waste and scheduling difficulty in existing cloud game control solutions.

The present disclosure provides a method for controlling a cloud game, an apparatus for controlling a cloud game, an electronic device, and a storage medium. In the method, N control instructions for N target cloud game resources in a same system instance are first acquired, wherein the system instance comprises M resource groups, each of the resource groups comprises interrelated cloud game applications, display resources, and processing resources, M and N are positive integers, and M is larger than or equal to N, then, in response to the N control instructions, a target resource group corresponding to each of the target cloud game resources is determined from the system instance; then each target cloud game application is displayed respectively through each target display resource in N target resource groups, each target cloud game resource is run respectively through the each target cloud game application, and a control operation corresponding to each control instruction is executed on the each target cloud game resource respectively; and finally, each target cloud game resource is processed respectively through each target processing resource in the N target resource groups to obtain N pieces of cloud game data, and the N pieces of cloud game data are returned to senders of the N control instructions respectively. In some embodiments of the present disclosure, a plurality of resource groups are established in the same system instance, and each of the resource groups has a complete set of cloud game applications, display resources, and processing resources. After a user issues a control instruction to a plurality of cloud game resources, for each of the cloud game resources, a display resource in a corresponding resource group displays a cloud game application; the cloud game application in the corresponding resource group runs the cloud game resource, and executes a corresponding control operation on the cloud game resource; a processing resource in the corresponding resource group processes the cloud game resource to obtain a piece of cloud game data in a particular format, and finally returns the cloud game data to the user; and different cloud games can achieve data isolation through different resource groups. Therefore, the present disclosure realizes the control of a plurality of cloud games in a single device through only one system instance, without the need to establish a plurality of system instances, thereby avoiding resource waste caused by repeated processes among a plurality of system instances. A single system instance can exclusively use device resources, thereby alleviating the scheduling difficulty caused by invoking a same resource by a plurality of system instances.

Technical solutions of embodiments of the present disclosure will be described clearly and completely below with reference to the drawings in the embodiments of the present disclosure. The described embodiments are merely some embodiments, instead of all embodiments, of the present disclosure. All other embodiments obtained by those skilled in the art based on the embodiments of the present disclosure without creative work are encompassed within the scope of protection of the present disclosure.

Embodiments of the present disclosure provide a method for controlling a cloud game, an apparatus for controlling a cloud game, an electronic device, and a computer-readable storage medium, wherein the apparatus for controlling a cloud game may be integrated in the electronic device, and the electronic device may be a device, such as a server or a terminal.

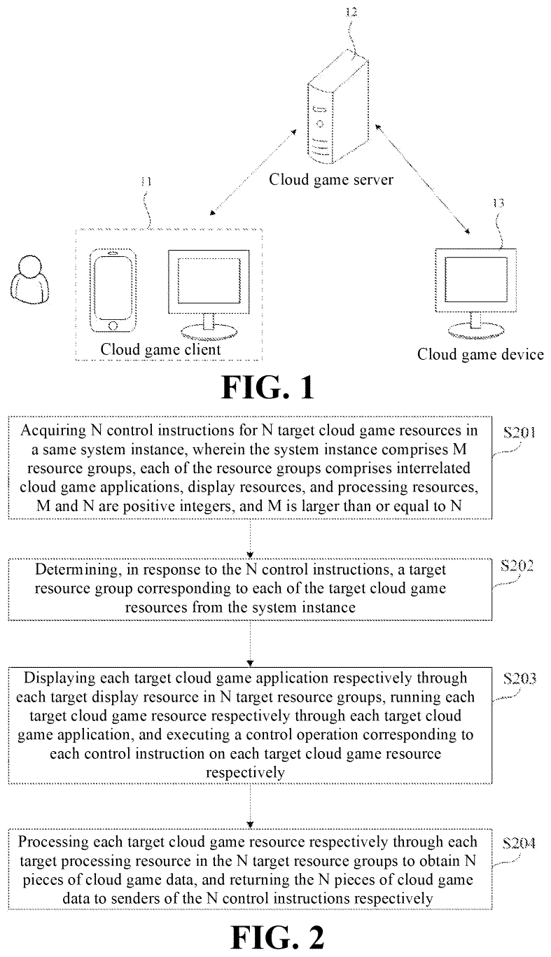

Referring to FIG. 1, FIG. 1 is a schematic diagram of an application scenario of a method for controlling a cloud game provided in an embodiment of the present disclosure. The scenario may comprise terminals and servers. There is communicative connection between the terminals, between the servers, and between the terminals and the servers through, e.g., the Internet composed of various gateways, wherein this application scenario comprises a cloud game client 11, a cloud game server 12, and a cloud game device 13; the cloud game client 11 is a device provided to a game player, can display a cloud game page, and has a man-machine interaction function, the cloud game server 12 comprises, e.g., a local server and/or a remote server, the cloud game device 13 is a device provided to a game staff, and the cloud game application is only installed in the cloud game device 13. When the cloud game device 13 uses a common chip, the cloud game server 12 and the cloud game device 13 may be different devices. When the cloud game device 13 uses a system-on-chip, the cloud game server 12 and the cloud game device 13 may be a same device.

The cloud game client 11, the cloud game server 12, and the cloud game device 13 are located in a wireless network or a wired network, to realize data interaction among the three, wherein:
the cloud game device 13 comprises a system instance, the system instance comprises M resource groups, and each of the resource groups comprises interrelated cloud game applications, display resources, and processing resources, wherein the cloud game application is an application program that implements game functions and carries cloud game resources, the cloud game resources are, e.g., a game audio and a game video, the display resources may be a virtual display in the cloud game device 13, the cloud game resources need to be displayed with the help of the display resources, and the processing resources may be tools for recording, encoding, and push streaming of the cloud game resources.

The game player issues N control instructions for N target cloud game resources in a same system instance of the cloud game device 13 respectively by using, e.g., a mouse, a keyboard, a stylus, and a touch input in a game interface of the cloud game client 11, wherein M and N are positive integers, and M is larger than or equal to N. In response to the N control instructions, the cloud game server 12 determines a target resource group corresponding to each target cloud game resource from the system instance, and then controls the cloud game device 13 to display each target cloud game application respectively through each display resource in the N target resource groups, run each target cloud game resource respectively through each target cloud game application, execute a control operation corresponding to each control instruction on each target cloud game resource respectively, process each target cloud game resource through each target processing resource in the N target resource groups to obtain N pieces of cloud game data, and return the N pieces of cloud game data to senders of the N control instructions respectively.

It should be noted that a schematic diagram of the system scenario shown in FIG. 1 is only an example. The server and the scenario are described in the embodiments of the present disclosure to more clearly illustrate the technical solutions of the embodiments of the present disclosure, and do not impose any limitation on the technical solutions provided in the embodiments of the present disclosure. As appreciated by those of ordinary skills in the art, with the evolution of the system and the emergence of new service scenarios, the technical solutions provided in the embodiments of the present disclosure are also adapted to similar technical problems. The detailed description will be provided below respectively. It should be noted that the order of description of the embodiments below does not impose any limitation on a preferred order of the embodiments.

In an embodiment of the present disclosure, referring to FIG. 2, FIG. 2 is a schematic flowchart of a method for controlling a cloud game provided in the embodiment of the present disclosure, specifically including:
S201: acquiring N control instructions for N target cloud game resources in a same system instance, wherein the system instance comprises M resource groups, each of the resource groups comprises interrelated cloud game applications, display resources, and processing resources, M and N are positive integers, and M is larger than or equal to N.

Cloud gaming refers to a gaming way based on cloud computing. In a running mode of the cloud game, an entity for running a game program is separated from an entity for presenting a game picture. The method for controlling a cloud game is completed on a cloud game server. A cloud game client is configured to receive data, transmit data, and present the game picture. For example, the cloud game client may be a display device that is close to a user side and has a data transmission function, such as a mobile terminal, a television set, a computer, or a handheld computer, but a terminal device that performs game data processing is a cloud game server on a cloud game server side. When playing the game, a player operates the cloud game client to transmit a control instruction to the cloud game server. The cloud game server runs the game based on the control instruction, encodes and compresses data such as a game video and a game audio, and returns the encoded and compressed data to the cloud game client through a network. Finally, the cloud game client decodes the encoded and compressed data, and outputs, e.g., the game picture and music.

In an embodiment of the present disclosure, resources required for an application program to be run are packaged on a device to obtain a complete and independent execution environment. All resources that constitute the execution environment constitute a system instance. Only one system instance can be created on a single device, or two or more system instances can be obtained through a virtualization or containerization technology. The device referred to in the present disclosure is a device on the cloud game server side, and the system instance is also located on the cloud game server side. The same system instance comprises M resource groups, each of the resource groups is used to control a cloud game, and then one system instance can be used to control M cloud games, wherein M is an integer larger than or equal to 2.

It should be noted that although the system instance of the present disclosure is mainly used to implement a plurality of cloud games on a single device, it does not constitute a limitation to a scenario where only one cloud game is implemented on a single device. When the system instance comprises only one resource group, it can also control a single cloud game.

In an embodiment of the present disclosure, the number of cloud games refers to a smallest unit of cloud game services provided to a single player. When the player initiates a game session on the cloud game client, the cloud game server returns a piece of cloud game data to a client of the player through the game session. A game session corresponds to a cloud game from starting creation to end. When a game session is re-established, it corresponds to a new cloud game.

In an embodiment of the present disclosure, the cloud game resources comprise a game audio, a game video, and other game-related data resources. The cloud game applications refer to application programs used to implement game functions. The cloud game applications have an activity configured to run the cloud game resources. When receiving a control instruction, the cloud game server will execute a control operation corresponding to the control instruction on the cloud game resources, so that the cloud game resources have various changes in the process, thus forming a cloud game video and a cloud game audio. The display resources refer to various hardware resources and software resources used to display the activity and corresponding cloud game resources. The processing resources refer to various hardware resources and software resources required in an entire process of data processing of the cloud game resources, so that they become cloud game data of particular types and in particular formats transmittable by a particular network, and are returned to the player through this particular network.

In an embodiment of the present disclosure, each resource group comprises interrelated cloud game applications, display resources, and processing resources. That is, cloud game resources in a cloud game application of a resource group can be displayed merely through a display resource of this resource group, and can be processed merely through a processing resource of this resource group. Cloud game applications of different resource groups may be applications of a same cloud game, or may be applications of different cloud games. Different cloud game applications correspond to different cloud game resources.

When a player can issue a control instruction for a cloud game resource on a game page of a cloud game client by using, e.g., a mouse, a keyboard, a stylus, and a touch input, the control instruction is acquired by the cloud game server. Since the system comprises M resource groups, at most M control instructions for M cloud game resources can be acquired. Each control instruction for one cloud game resource may be either a separate instruction or a compound instruction comprising a plurality of sub-control instructions.

In this step, the cloud game server acquires N control instructions for N target cloud game resources in the same system instance, wherein N is a positive integer, and M is larger than or equal to N. The N target cloud game resources may be for a given game, or may be for different games, or a part of them are for a given game, while the other part of them are for different games. The details may be associated with the number and types of a plurality of cloud game applications in the system instance. When there are 3 cloud game applications of game a in the system instance, at most merely 3 cloud game resources of the game a can be supported simultaneously.

In an embodiment, before the S201, the method further includes: creating M virtual displays based on a multi-display mode of the system instance; creating M users based on a multi-user mode of the system instance; and establishing a first association relationship between the users and the virtual displays. In an embodiment of the present disclosure, the system instance is a system instance created based on an Android10 (Q) system. The Android10 (Q) system supports the multi-display mode and the multi-user mode. The virtual displays and the users need to be created by first configuration and modification of open-source code AOSP of the Android10 (Q) system.

For the virtual displays, first a per-display focus function is enabled in the Android10 (Q) system. This function is a built-in function of the Android10 (Q) system, and can, after being enabled, support operation of a plurality of displays simultaneously. If this function is not enabled, only one of currently selected displays can be operated. The specific operation is:
configuring config_perDisplayFocusEnabled as true in frameworks/base/core/res/res/values/config.xml (attribute file).

Then, the multi-display mode is enabled. The specific operation is:
copying a file frameworks/native/data/etc/android.software.activities_on_secondary_displays.xml to a directory /system/etc/permissions of the android system.

Finally, the M virtual displays are created. For ease of description, M is 3 in the following embodiments of the present disclosure. The specific operation is:
creating 3 virtual displays using a tool MediaProjection. Create VirtualDisplay or a tool DisplayManager. Create VirtualDisplay in a built-in application of the system of the system instance.

After creation, the system automatically assigns a display identifier to each of the virtual displays, for example, the displayIDs are 1, 2, and 3 respectively.

For one of the users, a user type created in an embodiment of the present disclosure is a Managed Profile type, which is a user type designed by the Android system for an operating mode. This user type naturally supports display of Activities of the cloud game applications on display resources belonging to the user.

First, the managed users function is enabled in the Android10 (Q) system. The specific operation is:
copying a file frameworks/native/data/etc/android.software.managed_users.xml to a directory /system/etc/permissions of the android system.

Then, a limit value of the number of users in the system instance is modified. Since the system itself has a master user, and subsequently created users are all managed users, both the limit value of the number of managed users and a limit value of a total number of users need to be modified. The limit value of the number of managed users needs to be smaller than or equal to a maximum number of cloud games that can be simultaneously carried by a single system instance. A total number of newly created users in the system after modification should be smaller than or equal to the corresponding modified value. The specific operation is executing the following commands in a tool Android shell:
setprop persist.sys.max_profiles 3 (a maximum number of new users is 3); and
setprop fw.max_users 4 (the maximum number of new users is 4).

Then, a plurality of users of the Managed Profile type are created based on the multi-user mode obtained from the above setting operations. The specific operation is executing the following commands in the Android shell:
pm create-user-profileOf 0-managed user01 (creating user 01);
pm create-user-profileOf 0-managed user02 (creating user 02); and
pm create-user-profileOf 0-managed user03 (creating user 03).

After creation, the system automatically assigns a user identifier to each user. For example, the userIDs are 10, 11, and 12 respectively.

Finally, the users are started. The specific operation is executing the following commands in the Android shell:
am start-user 10 (starting user 01);
am start-user 11 (starting user 02); and
am start-user 12 (starting user 03).

Through the above processes, 3 virtual displays and 3 users are obtained. The virtual displays constitute display resources in each resource group of the system instance. Finally, the first association relationship between the users and the virtual displays is established by configuration in an application framework of the Android10 (Q) system, so that an Activity belonging to each user can only be displayed on a specified virtual display, and each virtual display can only display an activity of a specified user.

In an embodiment, after the establishing the first association relationship between the users and the virtual displays, the method further includes: acquiring user identifiers of the users; installing M cloud game applications to the M users in the system instance respectively, and assigning the user identifiers of the users to the cloud game applications; and establishing a second association relationship between the users and the cloud game applications based on the assignment result.

3 cloud game applications are installed to 3 users in the system instance respectively. Assuming that the 3 cloud game applications are each the given game a, the application name of the cloud game application is com.netease.sky. The specific operation is executing the following command in the Android shell:
pm install-exising-user 10 com.netease.sky (installing game a to user 01);
pm install-exising-user 11 com.netease.sky (installing game a to user 02); and
pm install-exising-user 12 com.netease.sky (installing game a to user 03).

Through this process, the second association relationship between the users and the cloud game applications is established. After installation, the user identifiers of the users are assigned to the cloud game applications, that is, each cloud game application has its own user identifier (UID). An association relationship between the cloud game applications and the virtual displays can be obtained based on the first association relationship and the second association relationship.

In addition, when the 3 cloud game applications correspond to different types of games, since the system supports simultaneously running different types of games, no further settings are required. However, when the 3 cloud game applications correspond to a given game, such as the given game a in the above embodiments, since the system defaults to only enabling one cloud game application simultaneously for the given game, it is further necessary to enable a multi-client game mode. After the multi-client mode is enabled, 3 same cloud game applications of the game a can be enabled simultaneously, and displayed on the 3 virtual displays simultaneously. The specific operation is executing the following commands in the Android shell:
am start-n com.netease.sky/com.netease.ntunisdk.external.protocol.ProtocolLauncher-user 10-display 1;
am start-n com.netease.sky/com.netease.ntunisdk.external.protocol.ProtocolLauncher-user 11-display 2; and
am start-n com.netease.sky/com.netease.ntunisdk.external.protocol.ProtocolLauncher-user 12-display 3.

In an embodiment, after the establishing the second association relationship between the users and the cloud game applications, the method further includes: acquiring user identifiers of the cloud game applications; establishing a third association relationship between the processing resources and the cloud game applications in the system instance based on the user identifiers; and obtaining the M resource groups based on the first association relationship, the second association relationship, and the third association relationship.

Since each of the cloud game applications has a unique user identifier, an invoking relationship between the processing resources and the user identifiers (UIDs) can be established, so that each of the processing resources can invoke a UID to capture a corresponding cloud game application, thereby processing a cloud game resource in a specified cloud game application by a specified processing resource, that is, establishing a third association relationship between the processing resources and the cloud game applications. The processing on cloud game resources in the virtual displays mainly includes recording, encoding, and push streaming. Moreover, the cloud game resources in the virtual displays mainly include an audio and a video. The audio and the video need to be recorded respectively, encoded respectively, and push streamed respectively. Therefore, the processing resources that perform the functions are first determined from the system instance, and then the invoking relationship between the processing resources and the user identifiers is established. Since each of the user identifiers corresponds to a certain cloud game application, the third association relationship between the processing resources and the cloud game applications can be established based on the invoking relationship.

After the first association relationship, the second association relationship, and the third association relationship are obtained, since each of the users is associated with a unique virtual display and associated with a unique cloud game application, and each of the cloud game applications is associated with a processing resource, each user has a group of unique and interrelated cloud game applications, virtual displays, and processing resources. All resources associated with each user constitute a resource group. In the system instance, a plurality of groups of resources are isolated by a plurality of users, and M resource groups can be obtained by M users.

S202: determining, in response to the N control instructions, a target resource group corresponding to each of the target cloud game resources from the system instance.

For a control instruction of each target cloud game resource, it is necessary to first determine the target resource group corresponding to the target cloud game resource from the M resource groups, and then control, display, and process the target cloud game resource through each resource of the target resource group.

In an embodiment, S202 specifically includes: acquiring, in response to the N control instructions, session information of N sessions corresponding to the N control instructions, and acquiring operating states of a plurality of display resources of the system instance; determining a target display resource corresponding to each target cloud game resource from the plurality of display resources of the system instance based on the control instructions, the session information, and the operating states; and determining the target resource group corresponding to each target cloud game resource based on the target display resource.

When a control instruction is transmitted from the cloud game client, the cloud game server first acquires session information of a current game session, the session information including a session identifier, acquires the operating states of the plurality of display resources of the system instance, the operating states including whether the display resources are used to display the cloud game resources, then can determine which game is controlled in response to a current request based on the control instruction, allocates a target display resource to each target cloud game resource from all display resources based on such information, and then determines a resource group where each target display resource is located as the target resource group corresponding to each target cloud game resource.

In an embodiment, the determining the target display resource corresponding to each target cloud game resource from the plurality of display resources of the system instance based on the control instructions, the session information, and the display state includes: ascertaining whether a new target resource group is to be allocated based on the session information; determining, in response to a new target resource group being to be allocated, a first cloud game application matching each target cloud game resource from M cloud game applications based on the control instructions, and determining a first display resource associated with each first cloud game application; and determining the target display resource corresponding to each target cloud game resource from each first display resource based on an operating state of the first display resource.

When a player creates a new game session at a cloud game client, the game session will generate a session identifier. If subsequent game operations are all performed in this game session, the session identifier will remain constant all along, during which the cloud game resources are all a same cloud game resource. If the current game session ends and a new game session is recreated, another session identifier is obtained, and a corresponding cloud game resource is also another cloud game resource. Therefore, the session identifier can be identified to determine whether a cloud game resource needs to be reallocated, and then determine whether a new target resource group is to be allocated. When a session identifier indicates a new game session, it means that a new target resource group is to be enabled. In this case, a game with a target cloud game resource requested by a game initiator is first determined based on the control instructions, then all first cloud game applications belonging to this game are found from the M cloud game applications, and then first display resources associated with these first cloud game applications are determined. The target cloud game resource can only be displayed in these first display resources. Operating states of the first display resources are analyzed. If a first display resource is displaying other cloud game resources, it cannot be used as the target display resource this time. Finally, N idle first display resources are determined from all idle first display resources based on a preset allocation rule as target display resources, and then allocated to N target cloud game resources respectively.

S203: displaying each target cloud game application respectively through each target display resource in N target resource groups, running each target cloud game resource respectively through each target cloud game application, and executing a control operation corresponding to each control instruction on each target cloud game resource respectively.

After the target resource groups are determined, the cloud game server displays, in response to each control instruction, an associated target cloud game application through a target display resource in a corresponding target resource group, runs the target cloud game resource in the target cloud game application, and executes a corresponding control operation on a running target cloud game resource in the target cloud game application, to present changes of the target cloud game resource in an entire process by the target display resource. For example, if a control instruction is used to control character a in game A to step forward, a game picture of the process of the character a stepping forward in the game A is displayed on the target display resource through the target cloud game application, and a corresponding game audio of this process is played at the same time.

When the above control operation on the game picture is executed, the target cloud game application can run a plurality of threads, including a logic thread used to implement a game drive logic and a rendering thread used to render the game picture. When acquiring the control instruction, the logic thread will process the control instruction in real time based on the game drive logic, then feeds back the processing result to the cloud game server, and feeds back the processing result to the rendering thread. The rendering thread will invoke resources such as a GPU to render the game picture, and return, after the rendering is successful, the rendering success result to the logic thread. Then, both the logic thread and the rendering thread continue to execute a next control instruction. Through the above process, changes of the game picture in the entire process are displayed on the target display resource.

S204: processing each target cloud game resource respectively through each target processing resource in the N target resource groups to obtain N pieces of cloud game data, and returning the N pieces of cloud game data to senders of the N control instructions respectively.

After a target processing resource corresponding to each target cloud game resource is obtained, a target cloud game resource running on the target display resource is processed through the target processing resource, to obtain cloud game data of particular types and in particular formats. The cloud game data is an encoded audio stream and an encoded video stream, and then each piece of cloud game data is returned to a sender of a corresponding control instruction respectively. After receiving the cloud game data, the sender obtains a complete game audio and a complete game video by decoding.

In an embodiment, S204 specifically includes: invoking a recording resource corresponding to each target cloud game resource to record a target cloud game resource among the target display resources, to obtain N pieces of recording data; invoking an encoding resource corresponding to each target cloud game resource to encode the recording data into the N pieces of cloud game data; and invoking a push streaming resource corresponding to each target cloud game resource to return the cloud game data to the senders of the control instructions.

The audio and the video of the target cloud game resource are processed separately. Therefore, each piece of recording data includes audio recording data and video recording data, and each piece of cloud game data includes encapsulated audio encoding data and encapsulated video encoding data.

For the audio, in the Android10 (Q) system, if the audio is to be captured from other applications, an application that implements the audio capture function needs to first construct an object AudioRecord, which completes recording the audio. Since a plurality of target cloud game applications in the system instance can run simultaneously, in order to separately record an audio of each of the target cloud game applications, an invoking relationship between a tool AudioPlaybackCaptureConfiguration.addMatchingUid( ) of built-in AudioPlaybackCapture API of the system and UIDs of the cloud game applications needs to be first established. Since the AudioPlaybackCaptureConfiguration.addMatchingUid( ) has a function of capturing an application audio with a particular UID, after the invoking relationship between the two is established, audios of the cloud game applications on different virtual displays can be recorded by invoking different UIDs. The audios are captured by the object AudioRecord, to obtain N pieces of audio recording data. Then, an interface of an audio encoder is invoked, to encode the captured audio recording data through the audio encoder into audio encoding data in a particular format. Finally, a push streaming interface is invoked to perform push streaming on encapsulated audio encoding data, and return the audio encoding data to a client issuing the control instruction.

In the above embodiments, the application audio with the particular UID is captured using a built-in application and a built-in interface of the system, which, however, does not impose any limitation on the present disclosure. A corresponding command line may also be directly compiled to record the audios of different cloud game applications based on different UIDs.

For the video, the video on the virtual display may be recorded using a scrcpy tool. The scrcpy tool has a display recording function. Similarly, an invoking relationship between display identifiers of to-be-recorded virtual displays and the tool needs to be first established, and then the tool is used to record a video on a specified virtual display. For example, a command is “scrcpy-display=1”, which means that a video is recorded on a virtual display with a display identifier of 1. Game videos on the virtual displays can be recorded based on different commands respectively to obtain N pieces of video recording data. After the videos are recorded, the scrcpy invokes an interface of a video encoder. The video encoder acquires the video recording data and encodes the video encoding data into video recording data in a particular format. Finally, a push streaming interface is invoked to perform push streaming on encapsulated video encoding data, so that the video encoding data is returned to a client issuing the control instruction.

After receiving the audio encoding data, the client can decode the audio encoding data into a game audio, and after receiving the video encoding data, the client can decode the video encoding data into a game video. By combining and synchronizing the two, a complete target cloud game resource can be obtained.

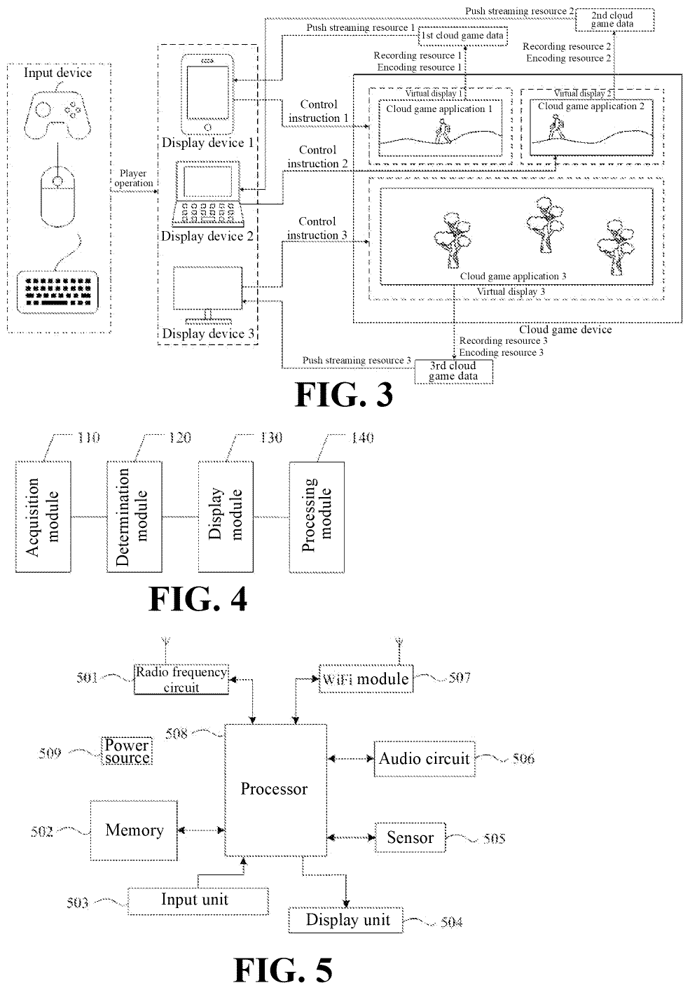

As shown in FIG. 3, it is an overall architecture diagram corresponding to the method in the above embodiments. As an example, the architecture implements 3 cloud games on a single device, the entire scenario includes an input device of a player, 3 display devices 1-3 of the player, and a cloud game device. The input device may comprise a device operable by the player, such as a gamepad, a mouse, or a keyboard. The display device may include a device with a display function, such as a smart phone, a PC, a smart TV, a set-top box, or VR glasses, is configured to provide the player with a game picture and a game audio, and provides a game interaction function. The input device is connected to the display device wiredly or wirelessly. The cloud game device has a system instance, and the system instance includes a plurality of resource groups.

Assuming that the display devices 1-3 are operated by players 1-3 respectively, the player 1 operates an input device connected to the display device 1, so that a relevant widget of a relevant interface in the display device 1 is triggered to generate a control instruction 1, and then the control instruction is transmitted through a game session to a cloud game server (not shown in the figure). In an initial state of the game session, content of the control instruction 1 may be enabling a game. In subsequent states, content of the control instruction 1 may be various game control instructions, such as controlling a character to move or rotate, controlling a character to use skills, controlling scenario transition, or controlling music play. In response to the control instruction 1, the cloud game server determines a resource group 1 as a target resource group from M resource groups of the system instance of the cloud game device. The resource group 1 includes a virtual display 1, a cloud game application 1, and a processing resource 1, and the processes resource 1 comprises a recording resource 1, an encoding resource 1, and a push streaming resource 1. Then, the cloud game application 1 is displayed through the virtual display 1, a video and an audio in a 1st cloud game resource are run through the cloud game application 1, and a control operation corresponding to the control instruction 1 is performed on the video and/or the audio, such as controlling a character x to walk leftward. A video and an audio generated in the entire control process are presented through the virtual display 1. Then, the video and the audio of the cloud game application 1 in the virtual display 1 are recorded respectively through the recording resource 1 to obtain video recording data and audio recording data, which are encoded through the encoding resource 1 respectively into video encoding data and audio encoding data. As a 1st piece of cloud game data, both are pushed to the display device 1 through the push streaming resource 1. In the display device 1, the video encoding data and the audio encoding data in the 1 st piece of cloud game data are decoded respectively, and then combined and synchronized. Finally, the game picture of the character x walking leftward and a corresponding game audio in the process are presented in the display device 1 to the player 1. Through the above process, a cloud gaming service is provided to the player 1.

For the player 2 and the player 3, the principle of acquiring a cloud gaming service is similar to the player 1. The player 2 issues a control instruction 2 through the input device and the display device 2, and determines the target resource group as a resource group 2. The resource group 2 includes a virtual display 2, a cloud game application 2, and a processing resource 2. The processing resource 2 comprises a recording resource 2, an encoding resource 2, and a push streaming resource 2. Through the above process, pushing of a 2nd piece of cloud game data is finally completed. The player 3 issues a control instruction 3 through the input device and the display device 3, and determines the target resource group as a resource group 3. The resource group 3 includes a virtual display 3, a cloud game application 3, and a processing resource 3. The processing resource 3 comprises a recording resource 3, an encoding resource 3, and a push streaming resource 3. Through the above process, pushing of a 3rd piece of cloud game data is finally completed. In the entire process, the control process of the players 1-3 and the process of obtaining the game picture and the audio do not affect each other.

Through the above process, a plurality of cloud game services are provided using a same system instance in a single cloud game device.

Current hardware solutions for cloud game server sides are roughly categorized into two categories. One category is controlling cloud games using a server plus a device with an ordinary chip, and the other category is controlling cloud games directly using a device with a system-on-chip as a server. When implementing a plurality of cloud games through a single device, both run a plurality of system instances on a single device using a virtualization technology (such as qemu, virtualbox, or vmware) or a containerization technology (such as lxc, docker, podman, or openshift). Each of the system instances completes control of a cloud game. Since each system instance includes an execution environment required to run a cloud game application, each system instance includes an init process, a system_server process, a surfaceflinger process, and some necessary system application processes, and even runs an independent kernel. When there are a plurality of system instances on a single device, these processes are repeated, thereby resulting in considerable expenditures. In addition, these system instances share resources such as a GPU and a CPU. When the plurality of system instances are running simultaneously, some system applications or processes need to simultaneously invoke the resources such as the GPU and the CPU, which will cause scheduling difficulty, and inflict adverse effects on running of the cloud game resources. Finally, since the plurality of system instances of the single device need to use the virtualization or containerization technology, the hardware solution of a device plus a system-on-chip is restricted by an application scenario of the system-on-chip, and a Linux system needs to be customized to obtain the plurality of system instances, thereby increasing the costs.

In embodiments of the present disclosure, a plurality of resource groups are established in a same system instance, and each of the resource groups has a complete set of cloud game applications, display resources, and processing resources. After a user issues a control instruction to a plurality of cloud game resources, for each of the cloud game resources, a display resource in a corresponding resource group displays a cloud game application; the cloud game application in the corresponding resource group runs the cloud game resource, and executes a corresponding control operation on the cloud game resource; a processing resource in the corresponding resource group processes the cloud game resource to obtain a piece of cloud game data in a particular format, and finally returns the cloud game data to the user; and different cloud games can achieve data isolation through different resource groups. Therefore, the present disclosure realizes the control of a plurality of cloud games in a single device through only one system instance, without the need to establish a plurality of system instances, thereby avoiding resource waste caused by repeated processes among a plurality of system instances. A single system instance can exclusively use device resources, thereby alleviating the scheduling difficulty caused by invoking a same resource by a plurality of system instances. Finally, since it is not necessary to run a plurality of system instances on a single device in the present disclosure, it is not necessary to use virtualization and containerization solutions, either. For the hardware solution of the system-on-chip, it is not necessary to customize the linux system, thereby reducing the costs.

Accordingly, as shown in FIG. 4, the present disclosure further provides an apparatus for controlling a cloud game, specifically comprising:
an acquisition module 110 configured to acquire N control instructions for N target cloud game resources in a same system instance, wherein the system instance comprises M resource groups, each of the resource groups comprises interrelated cloud game applications, display resources, and processing resources, M and N are positive integers, and M is larger than or equal to N;
a determination module 120 configured to determine, in response to the N control instructions, a target resource group corresponding to each of the target cloud game resources from the system instance;
a display module 130 configured to display each target cloud game application respectively through each target display resource in N target resource groups, run each target cloud game resource respectively through the each target cloud game application, and execute a control operation corresponding to each control instruction on the each target cloud game resource respectively; and
a processing module 140 configured to process each target cloud game resource respectively through each target processing resource in the N target resource groups to obtain N pieces of cloud game data, and return the N pieces of cloud game data to senders of the N control instructions respectively.

In an embodiment, the apparatus for controlling a cloud game further comprises:
a first creation module configured to create M virtual displays based on a multi-display mode of the system instance;
a second creation module configured to create M users based on a multi-user mode of the system instance; and
a first establishment module configured to establish a first association relationship between the users and the virtual displays.

In an embodiment, the apparatus for controlling a cloud game further comprises:
a first acquisition module configured to acquire user identifiers of the users;
an assignment module configured to install M cloud game applications to the M users in the system instance respectively, and assign the user identifiers of the users to the cloud game applications; and
a second establishment module configured to establish a second association relationship between the users and the cloud game applications based on the assignment result.

In an embodiment, the apparatus for controlling a cloud game further comprises:
a second acquisition module configured to acquire user identifiers of the cloud game applications;
a third establishment module configured to establish a third association relationship between the processing resources and the cloud game applications in the system instance based on the user identifiers; and
an obtainment module configured to obtain the M resource groups based on the first association relationship, the second association relationship, and the third association relationship.

In an embodiment, the determination module 120 comprises:
a first acquisition submodule configured to acquire, in response to the N control instructions, session information of N sessions corresponding to the N control instructions, and acquire operating states of a plurality of display resources of the system instance;
a first determination submodule configured to determine a target display resource corresponding to each target cloud game resource from the plurality of display resources of the system instance based on the control instructions, the session information, and the operating states; and
a second determination submodule configured to determine the target resource group corresponding to each target cloud game resource based on the target display resource.

In an embodiment, the first determination submodule comprises:
an ascertainment unit configured to ascertain whether a new target resource group is to be allocated based on the session information;
a first determination unit configured to determine, in response to a new target resource group being to be allocated, a first cloud game application matching each target cloud game resource from M cloud game applications based on the control instructions, and determine a first display resource associated with each first cloud game application; and
a second determination unit configured to determine the target display resource corresponding to each target cloud game resource from each first display resource based on an operating state of the first display resource.

In an embodiment, the processing module 140 comprises:
a first invoking submodule configured to invoke a recording resource corresponding to each target cloud game resource to record a target cloud game resource among the target display resources, to obtain N pieces of recording data;
a second invoking submodule configured to invoke an encoding resource corresponding to each target cloud game resource to encode the recording data into the N pieces of cloud game data; and
a third invoking submodule configured to invoke a push streaming resource corresponding to each target cloud game resource to return the cloud game data to the senders of the control instructions.

In the apparatus for controlling a cloud game of the present disclosure, the present disclosure establishes a plurality of resource groups in a same system instance, and each of the resource groups has a complete set of cloud game applications, display resources, and processing resources. After a user issues a control instruction to a plurality of cloud game resources, for each of the cloud game resources, a display resource in a corresponding resource group displays a cloud game application; the cloud game application in the corresponding resource group runs the cloud game resource, and executes a corresponding control operation on the cloud game resource; a processing resource in the corresponding resource group processes the cloud game resource to obtain a piece of cloud game data in a particular format, and finally returns the cloud game data to the user; and different cloud games can achieve data isolation through different resource groups. Therefore, the present disclosure realizes the control of a plurality of cloud games in a single device through only one system instance, without the need to establish a plurality of system instances, thereby avoiding resource waste caused by repeated processes among a plurality of system instances. A single system instance can exclusively use device resources, thereby alleviating the scheduling difficulty caused by invoking a same resource by a plurality of system instances.

Accordingly, an embodiment of the present disclosure further provides an electronic device. As shown in FIG. 5, the electronic device may comprise components, such as a radio frequency (RF) circuit 501, a memory 502 including one or more than one computer-readable storage medium, an input unit 503, a display unit 504, a sensor 505, an audio circuit 506, a WiFi module 507, a processor 508 including one or more than one processing core, and a power source 509. Those skilled in the art can understand that the structure of the electronic device shown in FIG. 5 does not constitute any limitation to the electronic device, and may include more or fewer components than those shown in the figure, or may combine some components, or may have different component arrangements, wherein:
the radio frequency circuit 501 may be configured to receive and transmit a signal during information transceiving or communication, particularly hand over, after receiving downlink information from a base station, it to one or more than one processor 508 for processing; and additionally transmit uplink data to the base station. The memory 502 may be configured to store software programs and modules, and the processor 508 executes various function applications and data processing by running the software programs and the modules stored in the memory 502. The input unit 503 may be configured to receive inputted digit or character information, and generate keyboard, mouse, joystick, optical or trackball signal input related to user settings and function control.

The display unit 504 may be configured to display information inputted by the user or information provided to the user, and various graphical user interfaces of a server. These graphical user interfaces may be composed of graphics, texts, icons, videos, and any combination thereof.

The electronic device may further comprise at least one sensor 505, such as an optical sensor, a motion sensor, and other sensors. The audio circuit 506 comprises a speaker that provides an audio interface between the user and the electronic device.

WiFi is a short-distance wireless transmission technology. The electronic device can help the use to, e.g., transceive an email, browse a web page, and access a streaming medium through the WiFi module 507, and provides the user with wireless broadband Internet access. Although FIG. 5 shows the WiFi module 507, it is understandable that this module is not a necessary component of the electronic device, and can be completely omitted within a range of not changing the essence of the application as needed.

The processor 508 is a control center of the electronic device, connects various parts of an entire mobile phone using various interfaces and wires, implements various functions of the electronic device by running or executing the software programs and/or the modules stored in the memory 502, and implements data processing by invoking data stored in the memory 502, thereby performing overall monitoring on the mobile phone.

The electronic device further comprises a power source 509 (such as a battery) that powers various components. Preferably, the power source may be logically connected to the processor 508 through a power management system, thereby managing functions such as charging, discharging, and power consumption management through the power management system.

Although not shown, the computer device may further comprise, e.g., a camera and a Bluetooth module, which will not be repeated here. Specifically, in this embodiment, the processor 508 in the server will load an executable file corresponding to processes of one or more than one application program into the memory 502 following instructions below, and the processor 508 runs the application program stored in the memory 502, thereby implementing functions below:
acquiring N control instructions for N target cloud game resources in a same system instance, wherein the system instance comprises M resource groups, each of the resource groups comprises interrelated cloud game applications, display resources, and processing resources, M and N are positive integers, and M is larger than or equal to N;
determining, in response to the N control instructions, a target resource group corresponding to each of the target cloud game resources from the system instance;
displaying each target cloud game application respectively through each target display resource in N target resource groups, running each target cloud game resource respectively through the each target cloud game application, and executing a control operation corresponding to each control instruction on the each target cloud game resource respectively; and
processing each target cloud game resource respectively through each target processing resource in the N target resource groups to obtain N pieces of cloud game data, and returning the N pieces of cloud game data to senders of the N control instructions respectively.

In an embodiment, the following functions are implemented:
creating M virtual displays based on a multi-display mode of the system instance;
creating M users based on a multi-user mode of the system instance; and
establishing a first association relationship between the users and the virtual displays.

In an embodiment, the following functions are implemented:
acquiring user identifiers of the users;
installing M cloud game applications to the M users in the system instance respectively, and assigning the user identifiers of the users to the cloud game applications; and
establishing a second association relationship between the users and the cloud game applications based on the assignment result.

In an embodiment, the following functions are implemented:
acquiring user identifiers of the cloud game applications;
establishing a third association relationship between the processing resources and the cloud game applications in the system instance based on the user identifiers; and
obtaining the M resource groups based on the first association relationship, the second association relationship, and the third association relationship.

In an embodiment, the following functions are implemented:
acquiring, in response to the N control instructions, session information of N sessions corresponding to the N control instructions, and acquiring operating states of a plurality of display resources of the system instance;
determining a target display resource corresponding to each target cloud game resource from the plurality of display resources of the system instance based on the control instructions, the session information, and the operating states; and
determining the target resource group corresponding to each target cloud game resource based on the target display resource.

In an embodiment, the following functions are implemented:
ascertaining whether a new target resource group is to be allocated based on the session information;
determining, in response to a new target resource group being to be allocated, a first cloud game application matching each target cloud game resource from M cloud game applications based on the control instructions, and determining a first display resource associated with each first cloud game application; and
determining the target display resource corresponding to each target cloud game resource from each first display resource based on an operating state of the first display resource.

In an embodiment, the following functions are implemented:
invoking a recording resource corresponding to each target cloud game resource to record a target cloud game resource among the target display resources, to obtain N pieces of recording data;
invoking an encoding resource corresponding to each target cloud game resource to encode the recording data into the N pieces of cloud game data; and
invoking a push streaming resource corresponding to each target cloud game resource to return the cloud game data to the senders of the control instructions.

The electronic device of the present disclosure establishes a plurality of resource groups in a same system instance, and each of the resource groups has a complete set of cloud game applications, display resources, and processing resources. After a user issues a control instruction to a plurality of cloud game resources, for each of the cloud game resources, a display resource in a corresponding resource group displays a cloud game application; the cloud game application in the corresponding resource group runs the cloud game resource, and executes a corresponding control operation on the cloud game resource; a processing resource in the corresponding resource group processes the cloud game resource to obtain a piece of cloud game data in a particular format, and finally returns the cloud game data to the user; and different cloud games can achieve data isolation through different resource groups. Therefore, the present disclosure realizes the control of a plurality of cloud games in a single device through only one system instance, without the need to establish a plurality of system instances, thereby avoiding resource waste caused by repeated processes among a plurality of system instances. A single system instance can exclusively use device resources, thereby alleviating the scheduling difficulty caused by invoking a same resource by a plurality of system instances.

In the above embodiments, particular emphasis is laid on description of each embodiment. The above detailed description may be referred to for parts that are not described in detail in an embodiment.

Those of ordinary skills in the art can understand that all or a part of the steps in the methods of the above embodiments can be completed through instructions, or be completed by controlling related hardware through instructions, wherein the instructions may be stored in a computer-readable storage medium, and loaded and executed by a processor.

To this end, an embodiment of the present disclosure provides a computer-readable storage medium, storing a plurality of instructions, wherein the instructions can be loaded by a processor to implement the following functions:
acquiring N control instructions for N target cloud game resources in a same system instance, wherein the system instance comprises M resource groups, each of the resource groups comprises interrelated cloud game applications, display resources, and processing resources, M and N are positive integers, and M is larger than or equal to N;
determining, in response to the N control instructions, a target resource group corresponding to each of the target cloud game resources from the system instance;
displaying each target cloud game application respectively through each target display resource in N target resource groups, running each target cloud game resource respectively through the each target cloud game application, and executing a control operation corresponding to each control instruction on the each target cloud game resource respectively; and
processing each target cloud game resource respectively through each target processing resource in the N target resource groups to obtain N pieces of cloud game data, and returning the N pieces of cloud game data to senders of the N control instructions respectively.

In an embodiment, the following functions are implemented:
creating M virtual displays based on a multi-display mode of the system instance;
creating M users based on a multi-user mode of the system instance; and
establishing a first association relationship between the users and the virtual displays.

In an embodiment, the following functions are implemented:
acquiring user identifiers of the users;
installing M cloud game applications to the M users in the system instance respectively, and assigning the user identifiers of the users to the cloud game applications; and
establishing a second association relationship between the users and the cloud game applications based on the assignment result.

In an embodiment, the following functions are implemented:
acquiring user identifiers of the cloud game applications;
establishing a third association relationship between the processing resources and the cloud game applications in the system instance based on the user identifiers; and
obtaining the M resource groups based on the first association relationship, the second association relationship, and the third association relationship.

In an embodiment, the following functions are implemented:
acquiring, in response to the N control instructions, session information of N sessions corresponding to the N control instructions, and acquiring operating states of a plurality of display resources of the system instance;
determining a target display resource corresponding to each target cloud game resource from the plurality of display resources of the system instance based on the control instructions, the session information, and the operating states; and
determining the target resource group corresponding to each target cloud game resource based on the target display resource.

In an embodiment, the following functions are implemented:
ascertaining whether a new target resource group is to be allocated based on the session information;
determining, in response to a new target resource group being to be allocated, a first cloud game application matching each target cloud game resource from M cloud game applications based on the control instructions, and determining a first display resource associated with each first cloud game application; and
determining the target display resource corresponding to each target cloud game resource from each first display resource based on an operating state of the first display resource.

In an embodiment, the following functions are implemented:
invoking a recording resource corresponding to each target cloud game resource to record a target cloud game resource among the target display resources, to obtain N pieces of recording data;
invoking an encoding resource corresponding to each target cloud game resource to encode the recording data into the N pieces of cloud game data; and
invoking a push streaming resource corresponding to each target cloud game resource to return the cloud game data to the senders of the control instructions.

The computer-readable storage medium of the present disclosure establishes a plurality of resource groups in a same system instance, and each of the resource groups has a complete set of cloud game applications, display resources, and processing resources. After a user issues a control instruction to a plurality of cloud game resources, for each of the cloud game resources, a display resource in a corresponding resource group displays a cloud game application; the cloud game application in the corresponding resource group runs the cloud game resource, and executes a corresponding control operation on the cloud game resource; a processing resource in the corresponding resource group processes the cloud game resource to obtain a piece of cloud game data in a particular format, and finally returns the cloud game data to the user; and different cloud games can achieve data isolation through different resource groups. Therefore, the present disclosure realizes the control of a plurality of cloud games in a single device through only one system instance, without the need to establish a plurality of system instances, thereby avoiding resource waste caused by repeated processes among a plurality of system instances. A single system instance can exclusively use device resources, thereby alleviating the scheduling difficulty caused by invoking a same resource by a plurality of system instances.

A method for controlling a cloud game, an apparatus for controlling a cloud game, an electronic device, and a computer-readable storage medium provided in the embodiments of the present disclosure are introduced in detail above. The principles and implementations of the present disclosure are set forth herein with reference to specific examples. The description of the above embodiments is only used to help understanding the technical solutions and core concepts of the present disclosure. Those with ordinary skills in the art should understand that: the technical solutions disclosed in the above embodiments may still be modified or a part of the technical features thereof may be replaced equivalently. These modifications or replacements are not intended to make the essence of corresponding technical solutions depart from the scope of the technical solutions of the embodiments of the present disclosure.

1. A method for controlling a cloud game, comprising:
acquiring N control instructions for N target cloud game resources in a system instance, wherein:
the system instance comprises M resource groups,
each of the resource groups comprises one or more interrelated cloud game applications, one or more display resources, and one or more processing resources,
M and N are positive integers, and
M is larger than or equal to N;
determining, based on the N control instructions, a respective target resource group corresponding to each respective target cloud game resource of the target cloud game resources;
displaying, for each respective target resource group, a respective target cloud game application through a respective target display resource;
running each respective target cloud game resource through the respective target cloud game application;
executing, on each respective target cloud game resource associated with a respective control instruction, a respective control operation corresponding to the respective control instruction;
processing each respective target cloud game resource through a corresponding target processing resource to obtain N pieces of cloud game data; and
returning the N pieces of cloud game data to one or more senders of the N control instructions.

2. The method of claim 1, further comprising:
creating M virtual displays based on a multi-display mode of the system instance;
creating M users based on a multi-user mode of the system instance; and
establishing one or more first association relationships between the users and the virtual displays.

3. The method of claim 2, wherein the system instance runs in an Android10 (Q) system, and creating the M virtual displays based on the multi-display mode of the system instance comprises:
enabling a per-display focus function and a multi-display mode of the Android10(Q) system;
creating the M virtual displays through at least one of a tool MediaProjection.CreateVirtualDisplay or a tool DisplayManager.CreateVirtualDisplay of the Android10 (Q) system; and
assigning one or more display identifiers to the M virtual displays.

4. The method of claim 3, wherein creating the M users based on the multi-user mode of the system instance comprises:
enabling a multi-user mode of the Android10 (Q) system;
creating the M users based on the multi-user mode; and
assigning one or more user identifiers to the M users, wherein a type of the users is a Managed Profile type.

5. The method of claim 2, further comprising:
acquiring one or more user identifiers of the users;
installing M cloud game applications to the M users in the system instance;
assigning the one or more user identifiers of the users to the cloud game applications; and
establishing one or more second association relationships between the users and the cloud game applications based on the assigned one or more user identifiers.

6. The method of claim 5, wherein the system instance runs in an Android 10 (Q) system, and the installing the M cloud game applications to the M users in the system instance comprises:
enabling a multi-client game mode of the Android 10 (Q) system; and
installing M same cloud game applications to the M users in the system instance.

7. The method of claim 5, further comprising:
acquiring the one or more user identifiers assigned to the cloud game applications;
establishing one or more third association relationships between the one or more processing resources and the cloud game applications in the system instance based on the one or more user identifiers; and
obtaining the M resource groups based on the one or more first association relationships, the one or more second association relationships, and the one or more third association relationships.

8. The method of claim 1, wherein determining, based on the N control instructions, the respective target resource group corresponding to each respective target cloud game resource of the target cloud game resources comprises:
acquiring, in response to the N control instructions, session information of N sessions corresponding to the N control instructions;
acquiring operating states of the one or more display resources of the system instance;
determining a respective target display resource, from the one or more display resources, corresponding to each respective target cloud game resource based on the control instructions, the session information, and the operating states; and
determining a respective target resource group corresponding to each target cloud game resource based on the respective target display resources.

9. The method of claim 8, wherein determining the respective target display resources comprises:
ascertaining to allocate a new target resource group based on the session information;
determining, in response to ascertaining to allocate a new target resource group, a respective cloud game application, from the M cloud game applications, matching each respective target cloud game resource based on the control instructions
determining a respective display resource associated with each respective cloud game application; and
determining the respective target display resource corresponding to each respective target cloud game resource based on an operating state of the respective display resource.

10. The method of claim 9, wherein determining the respective target display resources comprises:
determining one or more idle first display resources from the one or more display resources based on the operating states of the one or more display resources;
determining N target display resources from the one or more idle display resources based on a preset allocation rule; and
allocating the N target display resources to the N target cloud game resources.

11. The method of claim 1, wherein processing each respective target cloud game resource through the corresponding target processing resource, and returning the N pieces of cloud game data comprises:
invoking one or more recording resources corresponding to each respective target cloud game resource to record a respective target cloud game resource from a respective target display resource to obtain N pieces of recording data;
invoking one or more encoding resources corresponding to each respective target cloud game resource to encode the N pieces of recording data into the N pieces of cloud game data; and
invoking one or more push streaming resources corresponding to each target cloud game resource to return the N pieces of cloud game data to the one or more senders of the control instructions.

12. The method of claim 11, wherein the system instance runs in an Android10 (Q) system, and invoking the one or more recording resources comprises:
constructing an object AudioRecord in the Android10(Q) system;
establishing an invoking relationship between a tool AudioPlaybackCaptureConfiguration.addMatchingUid( ) of the Android10 (Q) system and one or more user identifiers of the cloud game applications;
recording an audio of a target cloud game application through the tool AudioPlaybackCaptureConfiguration.addMatchingUid( ) based on the invoking relationship; and
capturing the recorded audio through the object AudioRecord to obtain one or more pieces of audio recording data.

13. The method of claim 12, wherein invoking the one or more encoding resources comprises:
invoking an interface of an audio encoder; and
encoding the one or more pieces of audio recording data through the audio encoder into one or more pieces of audio encoding data.

14. The method of claim 13, wherein invoking the one or more push streaming resources comprises:
invoking a push streaming interface to perform push streaming on the one or more pieces of audio encoding data; and
returning the N pieces of audio encoding data to clients issuing the control instructions.

15. The method of claim 11, wherein the system instance runs in an Android10 (Q) system, and invoking the one or more recording resources comprises:
establishing an invoking relationship between a display identifier of one or more target virtual displays and a scrcpy tool; and
recording a game video of the one or more target virtual displays through the scrcpy tool based on the invoking relationship to obtain one or more pieces of video recording data.

16. The method of claim 15, wherein invoking the one or more encoding resources comprises:
invoking an interface of a video encoder; and
encoding the one or more pieces of video recording data through the video encoder into one or more pieces of video encoding data.

17. The method of claim 16, wherein invoking the one or more push streaming resources comprises:
invoking a push streaming interface to perform push streaming on the one or more pieces of video encoding data; and
returning the one or more pieces of video encoding data to clients issuing the control instructions.

18. (canceled)

19. An electronic device, comprising a memory and one or more processors, wherein the memory stores an application program, and the one or more processors are configured to run the application program in the memory to perform an operation for controlling a cloud game, comprising:
acquiring N control instructions for N target cloud game resources in a system instance, wherein:
the system instance comprises M resource groups,
each of the resource groups comprises one or more interrelated cloud game applications, one or more display resources, and one or more processing resources,
M and N are positive integers, and
M is larger than or equal to N;
determining, based on the N control instructions, a respective target resource group corresponding to each respective target cloud game resource of the target cloud game resources;
displaying, for each respective target resource group,-a respective target cloud game application through a respective target display resource;
running each respective target cloud game resource through the respective target cloud game application;
executing, on each respective target cloud game resource associated with a respective control instruction, a respective control operation corresponding to the respective control instruction;
processing each respective target cloud game resource through a corresponding target processing resource to obtain N pieces of cloud game data; and
returning the N pieces of cloud game data to one or more senders of the N control instructions.

20. A non-transitory computer-readable storage medium, storing a computer program thereon, wherein the computer program can be executed by one or more processors to perform an operation for controlling a cloud game, comprising:
acquiring N control instructions for N target cloud game resources in a system instance, wherein:
the system instance comprises M resource groups,
each of the resource groups comprises one or more interrelated cloud game applications, one or more display resources, and one or more processing resources,
M and N are positive integers, and
M is larger than or equal to N;
determining, based on the N control instructions, a respective target resource group corresponding to each respective target cloud game resource of the target cloud game resources;
displaying, for each respective target resource group,-a respective target cloud game application through a respective target display resource;
running each respective target cloud game resource through the respective target cloud game application;
executing, on each respective target cloud game resource associated with a respective control instruction, a respective control operation corresponding to the respective control instruction;
processing each respective target cloud game resource through a corresponding target processing resource to obtain N pieces of cloud game data; and
returning the N pieces of cloud game data to one or more senders of the N control instructions.

21. The electronic device of claim 19, wherein determining, based on the N control instructions, the respective target resource group corresponding to each respective target cloud game resource of the target cloud game resources comprises:
acquiring, in response to the N control instructions, session information of N sessions corresponding to the N control instructions;
acquiring operating states of the one or more display resources of the system instance;
determining a respective target display resource, from the one or more display resources, corresponding to each respective target cloud game resource based on the control instructions, the session information, and the operating states; and
determining a respective target resource group corresponding to each target cloud game resource based on the respective target display resources.
